(19) United States
(12) Patent Application Publication
(10) Pub. No.: US 2009/0181298 A1
(43) Pub. Date: Jul. 16, 2009

(54) INTEGRAL ELECTROCHEMICAL DEVICE

(75) Inventors: Grant Farrell, Chandler, AZ (US); Christo Brand, Langley (CA)

Correspondence Address: SNELL & WILMER L.L.P. (Main), 400 EAST VAN BUREN, ONE ARIZONA CENTER, PHOENIX, AZ, 85004-2202, US

(73) Assignee: EAGLEPICHER ENERGY PRODUCTS CORPORATION, Surrey (CA)

(21) Appl. No.: 12/350,770

(22) Filed: Jan. 8, 2009

Related U.S. Application Data
(60) Provisional application No. 61/020,328, filed on Jan. 10, 2008.

(51) Int. Cl. H01M 2/02; H01M 6/00; B23K 26/20

(52) U.S. Cl. 429/178; 29/623.1; 219/121.64

(57) ABSTRACT

According to various embodiments, an electrochemical device is provided that comprises an anode terminal pin electrically coupled with an anode, a cathode terminal pin electrically coupled with a cathode, and a terminal surface configured to receive the anode terminal pin and the cathode terminal pin. The electrochemical device may further comprise a shared surface that is configured to interface with the terminal surface to produce an electrode housing, and the shared surface may be configured to be shared between the integral electrochemical device and an apparatus that is configured to receive power from the integral electrochemical device

### CROSS-REFERENCE TO RELATED APPLICATIONS

This application is a non-provisional of U.S. Provisional No. 61/020,328, filed on Jan. 10, 2008, and entitled, “INTEGRAL ELECTROCHEMICAL DEVICE.”

### BACKGROUND

One factor generally taken into account when designing an electrochemical device such as a battery is the energy density of the device. Many factors may influence the energy density, for example, the chemistry of the electrodes in the electrochemical device. Another influencing factor is the space required to make internal connections between the electrodes and the device terminals. This space may be referred to as the head space of the device.

For electrochemical devices used within medical apparatuses, size and weight constraints on the electrochemical devices become more stringent because the design of medical apparatuses generally minimizes the overall size of the apparatus. The design of electrochemical devices for use in medical apparatuses therefore should focus on ways to decrease the size and weight of the electrochemical device while providing a desired total energy.

### SUMMARY

In various embodiments, an integral electrochemical device is provided that may comprise an anode terminal pin electrically coupled with an anode, and a cathode terminal pin electrically coupled with a cathode. The integral electrochemical device may also comprise a terminal surface configured to receive the anode terminal pin and the cathode terminal pin, and a shared surface configured to interface with the terminal surface to produce an electrode housing. The shared surface may be configured to be shared between the integral electrochemical device and an apparatus that is configured to receive power from the integral electrochemical device.

A medical apparatus, according to various embodiments, may comprise an electrode stack that comprises an anode and a cathode, and the electrode stack may be configured to power the medical apparatus. The medical apparatus may further comprise an anode terminal pin electrically coupled with the anode, a cathode terminal pin electrically coupled with the cathode, and a terminal surface configured to receive the anode terminal pin and the cathode terminal pin. The medical apparatus may further comprise a shared surface that is configured to interface with the terminal surface to house the electrode stack.

According to further various embodiments, an electrochemical device is provided that may comprise an anode terminal pin electrically coupled with an anode, a cathode terminal pin electrically coupled with a cathode, and a terminal surface configured to receive the anode terminal pin and the cathode terminal pin. The electrochemical device may further comprise a shared surface that is configured to interface with the terminal surface to produce an electrode housing, and the shared surface may be configured to be shared between the integral electrochemical device and an apparatus that is configured to receive power from the integral electrochemical device.

A method, in accordance with various embodiments, may comprise forming an anode hole in an anode and a cathode hole in a cathode, inserting an anode terminal pin through the anode hole, inserting a cathode terminal pin through the cathode hole, and securing a terminal surface to the anode terminal pin and the cathode terminal pin. The method may further comprise securing the terminal surface to a shared surface of an apparatus, and the anode and the cathode may provide power to the apparatus.

### BRIEF DESCRIPTION OF THE DRAWING FIGURES

The drawing figures in this document illustrate various embodiments that may include part or all of the features shown in one of these figures, or may include features from two or more figures. Embodiments may also include features described in the specification, or limitations to features described in the specification. Furthermore, embodiments may include features that would be familiar to a person of ordinary skill in the art who has studied this document.

FIG. 1A illustrates a perspective view of a prismatic battery.

FIG. 1B illustrates a side cross sectional view of a prismatic battery disposed within an apparatus.

FIG. 2 illustrates a side cross sectional view of an integral battery according to an embodiment of the present invention.

FIG. 3 illustrates a side cross sectional view of another configuration of an exemplary integral battery.

FIG. 4 illustrates a side cross sectional view of yet another configuration of an exemplary integral battery.

FIG. 5A illustrates a top cut-away view of an electrode stack disposed within an integral battery according to an exemplary embodiment.

FIG. 5B illustrates a partial side cross sectional view of a terminal and feed-through configuration according to an exemplary embodiment.

FIG. 6 illustrates a schematic cross sectional view of a portion of an electrode stack according to an embodiment of the present invention.

FIG. 7 illustrates another schematic cross sectional view of an electrode stack according to an embodiment of the present invention.

FIG. 8 illustrates a top view of an electrode stack in accordance with still another embodiment of the invention.

FIG. 9 illustrates a schematic view of an exemplary electrode pair comprising a tab connector.

FIG. 10 illustrates a schematic side view of an electrode stack according to an embodiment of the invention.

FIG. 11 illustrates a schematic side view of an electrode stack connected to a terminal pin according to an embodiment of the invention.

### DETAILED DESCRIPTION

The detailed description of various exemplary embodiments herein makes reference to the accompanying drawing figures. While these embodiments are described in sufficient detail to enable those of ordinary skill in the art to practice the invention, it should be understood that other embodiments may be realized and that changes may be made without departing from the spirit and scope of this disclosure. Thus, the detailed description herein is presented for purposes of illustration only and not of limitation.

An exemplary integral electrochemical device according to various embodiments of the present invention comprises a battery. Other electrochemical devices such as capacitors are contemplated within the scope of the present disclosure. Therefore, although a battery may be referred to throughout this disclosure, the disclosure is not limited only to batteries, but also to other electrochemical devices that are capable of being made with the structure and/or by the processes and methods disclosed herein.

An integral battery according to embodiments of the present invention comprises at least one wall, side, and/or surface that is shared between the integral battery and the apparatus into which the integral battery is incorporated. For example, the integral battery may be used within a medical apparatus that is designed to be implanted in the human body. The integral battery may also be used in any number of apparatuses that require a power source.

In addition to the wall shared between the integral battery and the apparatus (“shared surface”), the integral battery also comprises a wall, side and/or surface that is configured to enclose a plurality of electrodes within the integral battery. This enclosing wall may also be configured to comprise the terminals of the integral battery, and is therefore referred to herein as the “terminal surface” or “terminal wall.”

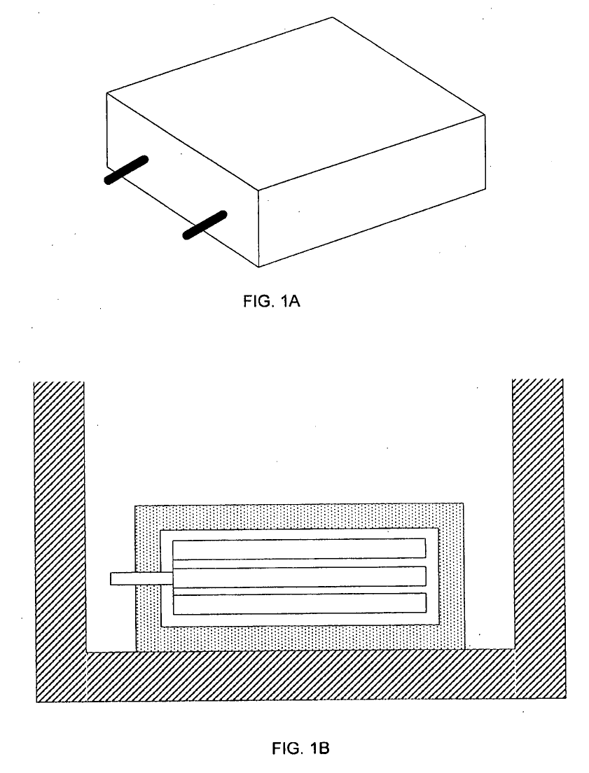

Various embodiments of the integral battery comprise shared surfaces and terminal surfaces that individually comprise different numbers of walls. For example, a standard battery configuration may comprise a cell housing with six sides, such as where the cell housing comprises a six-sided rectangular prism, as shown in FIG. 1A. In order to adapt the standard battery configuration for use as an integral battery, some of the six sides are configured to be part of the shared surface, and the remaining walls are configured to be part of the terminal surface. For purposes of definition, the shared surface and terminal surface will be referred to collectively herein as the integral electrode housing. Such a definition helps to distinguish the structure of the integral battery from the structure of a standard battery where the cell housing contains the electrodes separately from the apparatus into which the standard battery is installed.

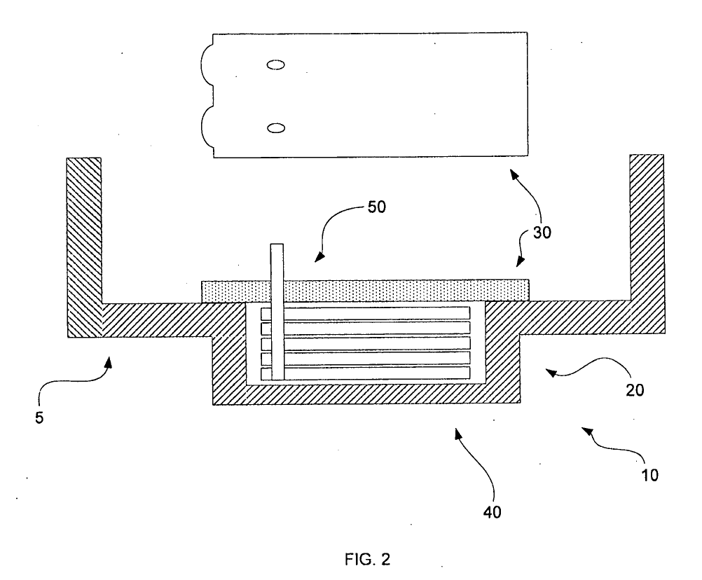

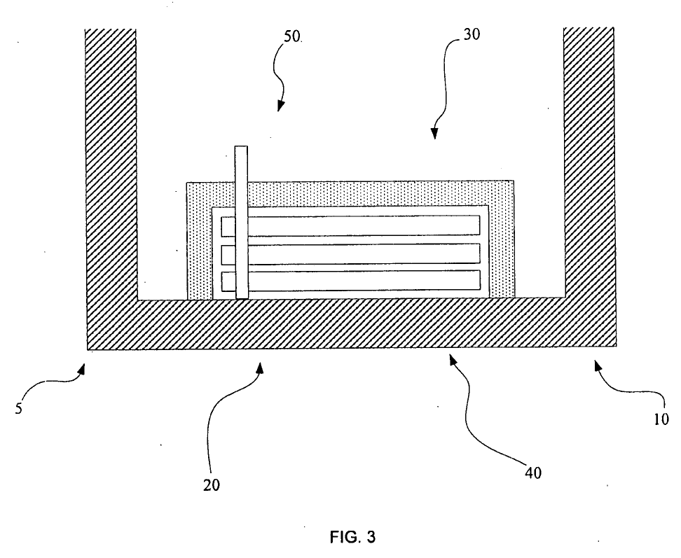

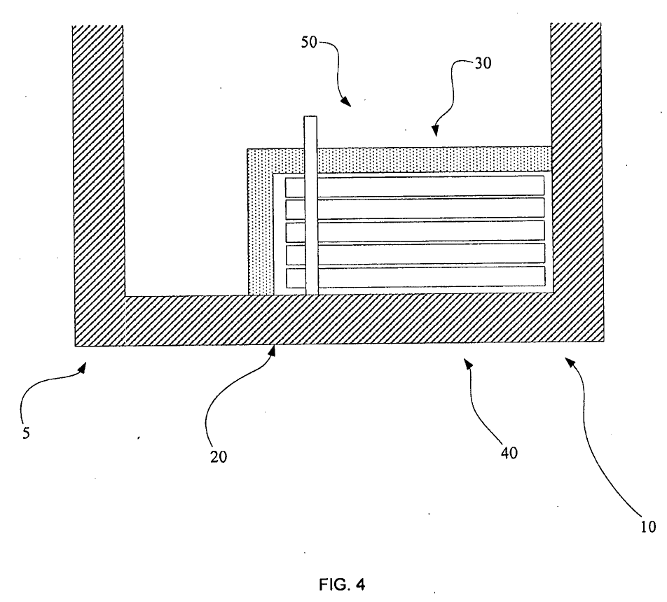

In one embodiment, as illustrated in FIG. 2, where the integral electrode housing comprises six sides, the shared surface may comprise five sides of the integral electrode housing, and the terminal wall may comprise one side of the integral electrode housing. In another embodiment, as illustrated in FIG. 3, the shared surface may comprise one side of the integral electrode housing, and the terminal wall may comprise five sides of the integral electrode housing. In still another embodiment, as illustrated in FIG. 4, the shared surface may comprise two sides of the integral electrode housing, and the terminal surface may comprise four sides of the integral electrode housing. It should be understood that any number of configurations and numbers of sides are contemplated within the scope of the present disclosure regarding the integral electrode housing. For example, where the electrodes are D-shaped, the integral electrode housing may be configured to be D-shaped, and the shared surface and terminal surface may comprise any number of sides required to hermetically enclose the electrodes.

In an exemplary embodiment of the invention, the number of walls within an apparatus may be reduced by using part of the housing of the apparatus into which the integral battery will be formed as part of the integral battery. For example, FIG. 1B illustrates a standard battery disposed in an apparatus, and shows the double wall thickness where the standard battery contacts the side of the apparatus. FIG. 2 illustrates, on the other hand, an exemplary integral battery 10 with a shared surface 20 disposed within an apparatus 5. Such an embodiment reduces the number of structural walls and/or portions within apparatus 5, thereby making more room for the active parts of integral battery 10. Increasing room for the active parts of integral battery 10 such as the electrodes will allow for greater electrical capacity, greater energy density, and reduced weight. In another embodiment, integral battery 10 is configured to allow the size of apparatus 5 to decrease without decreasing the electrical capacity and/or energy density of the electrochemical device that powers the apparatus.

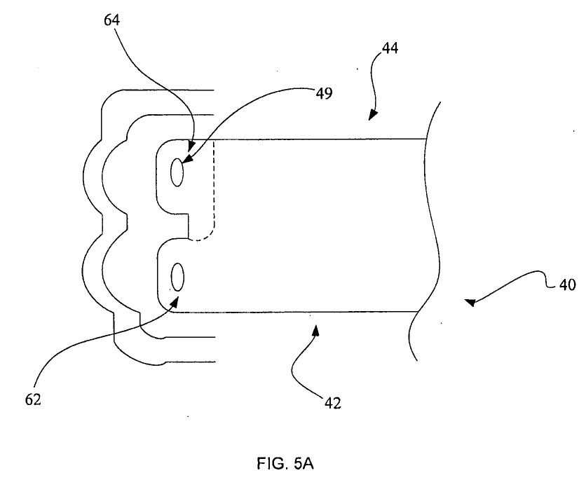

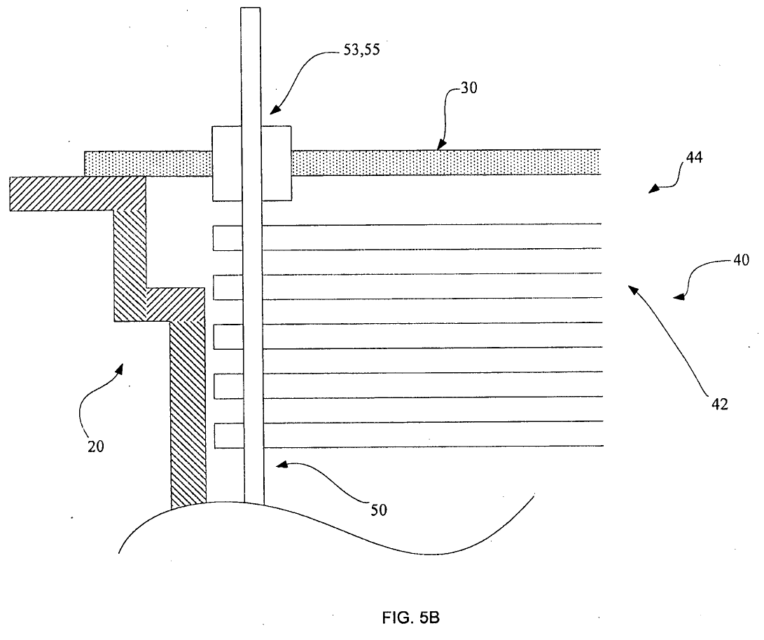

Various embodiments of the integral battery comprise a number of electrodes, such as positive and negative electrodes, and/or cathodes and anodes. An exemplary integral battery comprises a stacked plate electrode configuration. Methods for constructing stacked plate electrochemical devices are known in the art, and any such method is within the scope of the present disclosure. For example, with reference to FIGS. 5 and 6, an exemplary integral battery 10 comprises an electrode stack 40 that comprises alternating anodes 44 and cathodes 42. Between the alternating anodes 44 and cathodes 42, a separator 46 may be disposed. An integral battery as disclosed herein may be used with any electrode and separator chemistry and/or structure that is operative to form the stacked plate configuration of electrode stack 40.

With reference now to FIGS. 2 and 5A-5B, electrode stack 40 is configured to receive terminal pin 50 in a substantially perpendicular fashion to electrode stack 40. An exemplary integral battery 10 comprises a cathode terminal pin 52 configured to collect the current from cathodes 42, and an anode terminal pin 54 configured to collect the current from anodes 44. Cathodes 42 and anodes 44 may comprise terminal pin holes 49 configured to receive cathode terminal pin 52 and anode terminal pin 54. Terminal pins 52, 54 may comprise molybdenum. In other embodiments, the terminal pins may comprise any material configured to collect current from electrodes 42, 44.

Where terminal pins 52, 54 are configured to pass directly through electrodes 42, 44, it may not be necessary to employ separate current collectors to connect electrodes 42, 44 to terminal pins 52, 54. For example, a small area may be cleaned on both sides of each electrode around terminal pin holes 49 to expose the foil or other electrode substrate on which the electrode material was populated. Terminal pin holes 49 may then be punched in the cleaned area so that a connection may be made between the foil and terminal pins 52, 54, for example by welding. Terminal pin holes 49 may also be punched prior to cleaning electrodes 42, 44.

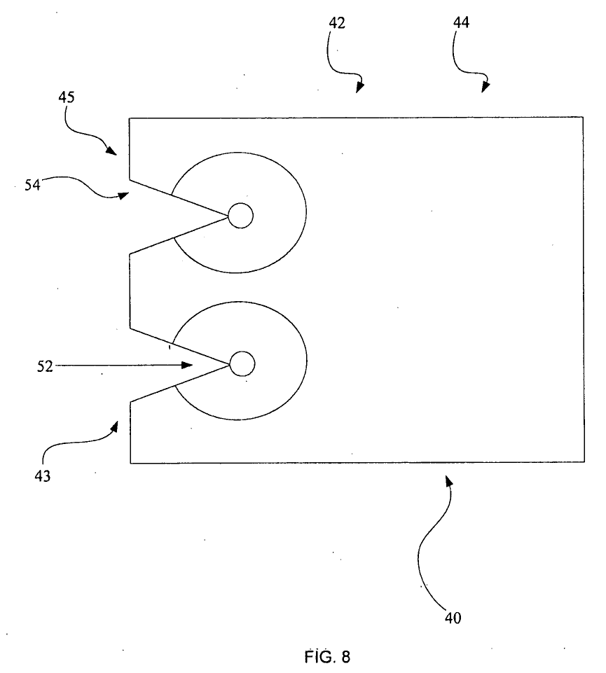

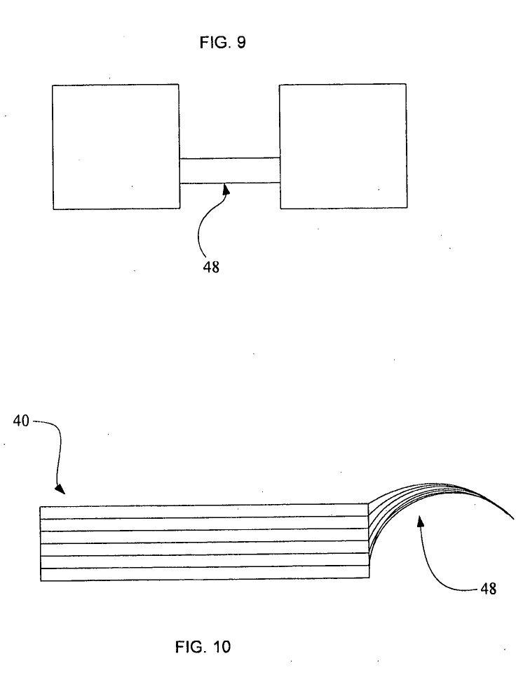

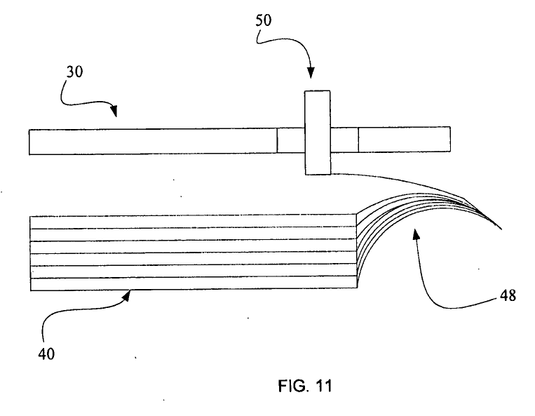

In other embodiments of integral battery 10, for example, with momentary reference to FIGS. 9-11, current collectors may still be employed. In one embodiment, electrodes 42, 44 may be configured to comprise a tab connector 48 between a pair of electrodes. Each pair of electrodes may be formed from a single electrode that is punched and cleaned to expose tab connector 48. In another embodiment, tab connector 48 may be welded to two electrodes to form the pair. Pairs of cathodes and anodes may then be folded together such that tab connectors 48 for the anodes are on one side of electrode stack 40 and tab connectors 48 for the cathodes are on the other side of electrode stack 40. In such a configuration, the anode tab connectors may be welded together and then welded to anode terminal pin 54, and the cathode tab connectors may be welded together and then welded to cathode terminal pin 52. It is possible to trim tab connectors 48 in order to minimize the space tab connectors 48 take up in integral battery 10 thereby reducing the head space.

While one embodiment of the invention comprises terminal pins that are substantially perpendicular to electrodes 42, 44, an integral battery may also be configured to comprise terminal pins that are substantially parallel to electrodes 42, 44. For example, the terminal pins may extend from terminal surface 30 in a direction substantially parallel to electrodes 42, 44. In such an embodiment, tab connectors may be employed and welded to terminal pins 52, 54 similar to the manner illustrated in FIGS. 9-11. In another embodiment, tab headers for use in non-integral batteries may be employed with terminal surface 30 in integral battery 10.

FIG. 5A illustrates a top view of electrode stack 40, showing one configuration of electrodes 42, 44. Anode 44 may comprise an anode terminal portion 64 extending from the main body of anode 44 configured to receive anode terminal pin 54. Similarly, cathode 42 may comprise a cathode terminal portion 62 extending from the main body of cathode 42 configured to receive cathode terminal pin 52. In one embodiment, a substantially rectangular anode 44 may be formed, and then a portion may be removed from the substantially rectangular anode. The removed portion from anode 44 is configured to allow cathode terminal pin 52 to run substantially parallel to anode terminal pin 54 without contacting anode 44. Other configurations of cathode 42 and anode 44 are within the scope of the present disclosure where the configurations allow cathode terminal pin 52 to pass through cathodes 42 without contacting anodes 44, and where the configurations allow anode terminal pin 54 to pass through anodes 44 without contacting cathodes 42.

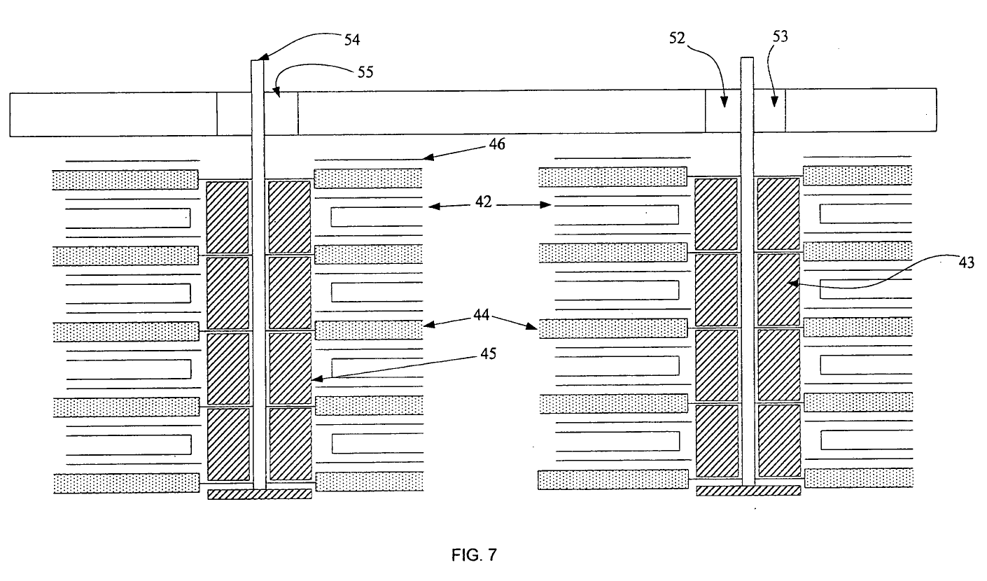

With momentary reference to FIG. 8, in addition to forming terminal pin holes 49, anode terminal portion 64 and cathode terminal portion 62 may also be cut open on an angle, thereby exposing terminal pin holes 49. Such a configuration may allow terminal pins 52, 54 to be welded to electrodes 42, 44 at electrode terminal portions 62, 64 using a laser weld.

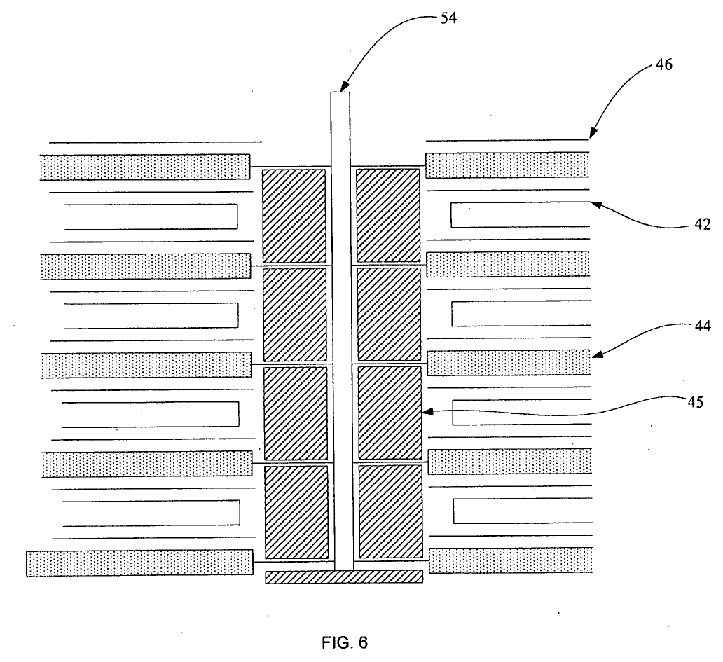

With reference now to FIGS. 6-7, where electrode material is removed from electrodes 42, 44 in order to form a contact surface for terminal pins 52, 54, and where separator 46 is disposed between each layer of electrode, a gap may exist between electrodes 42, 44 when they are stacked to form electrode stack 40. To fill this gap, cathode disks 43 may be disposed between cathode terminal portions 62 and anode disks 45 may be disposed between anode terminal portions 64. In an exemplary embodiment, cathode disks 43 comprise aluminum disks, and anode disks 45 comprise copper disks. However, it should be understood that other separating disks may be used that are configured to allow current to flow in the integral battery. In other embodiments, the electrode substrate may be configured such that disks 43, 45 are not required.

In an exemplary embodiment, and with reference again to FIGS. 2 and 5A-5B, terminal surface 30 may be configured to receive terminal pins 52, 54. In some embodiments, it is desirable to isolate terminal pins 52, 54 from terminal surface 30. In other embodiments, however, for example where terminal surface may comprise the negative terminal of integral battery 10, one of the terminal pins may not exist and/or may not be isolated from terminal surface 30. However, it should be noted that where terminal surface 30 comprises the negative terminal of integral battery 10, shared surface 20 would be electrically insulated from terminal surface 30.

In order to facilitate isolating terminal pins 52, 54 from terminal surface 30, isolating cathode feed-through 53 and isolating anode feed-through 55 may be employed. Isolating feed-throughs 53, 55 may be configured to receive terminal pins 52, 54 and to electrically insulate and/or isolate them from terminal surface 30. Exemplary isolating feed-throughs 53, 55 may comprise glass that is sealed to terminal surface 30 using a glass to metal seal.

An exemplary method of assembling integral battery 10 will now be described with reference to FIGS. 5A through 8. It should be understood, however, that these steps may be performed in any order that results in the formation of integral battery 10 as disclosed above. After forming electrodes 42, 44 with terminal pin holes 49 in terminal portions 62, 64 and/or cutting terminal portions 62, 64 to allow for laser welding, electrode stack 40 may be assembled.

In one embodiment, a cell pack insulator may be used as a stacking aid. Terminal pins 52, 54 are positioned substantially parallel to each other at the appropriate position to receive their corresponding electrodes. In another embodiment, only one pin may be used as a stacking aid, and the other pin may be inserted after the electrode stack is completed. Then an anode 44 is stacked by sliding anode pin 54 through the terminal pin hole, thereby forming the bottom electrode of electrode stack 40. In other embodiments, a cathode may form the bottom electrode of the electrode stack. An anode disk is then stacked on top of anode 44 by receiving anode pin 54 through a hole in anode disk 45. A separator is then stacked on top of anode 44, such that anode 44 is covered by separator 46, but anode disk 45 is not covered by separator 46. Separators 46 are disposed between anodes 44 and cathodes 42. The same process is repeated with cathodes 42, cathode disks 53, and separators 46. Alternating anodes and cathodes are then stacked with corresponding disks and with separators in between until a desired number of electrodes exist in electrode stack 40.

After the electrodes, separators, and disks have been stacked, the electrode stack is welded together. In one embodiment, as illustrated in FIG. 8, where a portion is cut away from terminal portions 62 and 64, terminal pins 52, 54 may be laser welded to electrodes 42, 44 and electrode disks 43, 45. In another embodiment, as illustrated in FIGS. 5A-5B, where there is no cut-away portion, electrodes 42, 44 and electrode disks 43, 45 may be ultrasonically welded to terminal pins 52, 54. Other methods operative to secure the terminal pins to the electrodes and electrode disks are within the scope of the present invention. With the electrode stack formed, the stack is then turned upside down, and a final disk is welded, for example by laser welding, on to each of cathode pin 52 and anode pin 54. If only one pin was used as a stacking guide, the other pin is inserted through the holes in the electrodes, separators, and electrode disks prior to welding the final disk on to the pin. In embodiments, as illustrated in FIG. 8, where a laser weld is used to weld the terminal pins to the electrodes, it is not necessary to use a final disk on the bottom of the pins. Securing electrode stack 40 according to embodiments of the invention results in improved reliability of the terminations inside the battery because the electrodes are configured to be connected directly to the terminal pins, and gathering and/or grouping of electrodes and/or current collectors is not required.

In some embodiments of the integral battery, one or both of the terminal pins may be secured to terminal surface 30 via feed-throughs 53, 55 prior to stacking the electrodes such that both pins are inserted through the electrode stack at the same time. In other embodiments, the terminal pins are secured to terminal surface 30 after the electrode stacking process.

With electrodes 42, 44 stacked and welded on to terminal pins 52, 54, and with terminal pins 52, 54 secured to terminal surface 30, an exemplary integral battery may be completed by hermetically sealing terminal surface 30 to shared surface 20. For example, terminal surface may be hermetically sealed to shared surface 20 via a laser weld.

As discussed above, exemplary integral batteries as disclosed herein may result in improved packaging efficiency and energy density. Also, since the integral battery assembly process may be part of the medical apparatus assembly process, proper handling of the battery during apparatus assembly may be supervised and monitored. Furthermore, additional packaging to send a battery to an apparatus assembler is not required, thereby conserving environmental resources. Moreover, apparatus design may be simplified by not requiring additional apparatus components to secure the integral battery into the apparatus.

It should be understood that while the present invention has been described in connection with an integral battery, various aspects of the invention may be applicable to other battery configurations. For example, the terminal pin configuration disclosed herein may be applicable to standard battery configurations that are not integral batteries. Using the exemplary side terminal pin configuration is desirable to reduce head space required for making connections between the electrodes and the terminal pins. It is not necessary to use the disclosed side terminal pin configuration in connection with an integral battery.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, and C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. An integral electrochemical device, comprising:
an anode terminal pin electrically coupled with an anode;
a cathode terminal pin electrically coupled with a cathode;
a terminal surface configured to receive the anode terminal pin and the cathode terminal pin; and
a shared surface configured to interface with the terminal surface to produce an electrode housing, wherein the shared surface is configured to be shared between the integral electrochemical device and an apparatus that is configured to receive power from the integral electrochemical device.

2. The integral electrochemical device of claim 1, wherein the terminal surface and the shared surface individually comprise a different number of sides.

3. The integral electrochemical device of claim 2, wherein the terminal surface comprises one side, and wherein the shared surface comprises two sides.

4. The integral electrochemical device of claim 2, wherein the terminal surface comprises four sides, and wherein the shared surface comprises two sides.

5. The integral electrochemical device of claim 1, wherein the integral electrochemical device is a rectangular prismatic battery.

6. The integral electrochemical device of claim 1, wherein the integral electrochemical device is a D-shaped, stacked plate battery.

7. The integral electrochemical device of claim 1, wherein the anode comprises an anode hole configured to receive the anode terminal pin, and wherein the cathode comprises a cathode hole configured to receive the cathode terminal pin.

8. The integral electrochemical device of claim 7, wherein an anode material is configured to be removed around the anode hole to at least partially expose an anode substrate, wherein a cathode material is configured to be removed around the cathode hole to at least partially expose a cathode substrate, and wherein the anode terminal pin is electrically coupled with the anode substrate and the cathode terminal pin is electrically coupled with the cathode substrate.

9. The integral electrochemical device of claim 8, wherein the anode hole and the cathode hole are configured to facilitate electrical connection of the anode substrate to the anode terminal pin and of the cathode substrate to the cathode terminal pin.

10. The integral electrochemical device of claim 9, wherein the anode terminal pin is configured to be electrically coupled with the anode substrate via laser welding, and wherein the cathode terminal pin is configured to be electrically coupled with the cathode substrate via laser welding.

11. The integral electrochemical device of claim 8, wherein the anode terminal pin is configured to be electrically coupled with the anode substrate via ultrasonic welding, and wherein the cathode terminal pin is configured to be electrically coupled with the cathode substrate via ultrasonic welding.

12. The integral electrochemical device of claim 1, wherein the anode terminal pin is electrically connected to the anode without using a current collector between the anode and the anode terminal pin, and wherein the anode terminal pin is substantially perpendicular to the anode.

13. The integral electrochemical device of claim 1, wherein the cathode terminal pin is electrically connected to the cathode without using a current collector between the cathode and the cathode terminal pin, and wherein the cathode terminal pin is substantially perpendicular to the cathode.

14. The integral electrochemical device of claim 1, further comprising:
an anode current collector electrically connected between the anode and the anode terminal pin; and
a cathode current collector electrically connected between the cathode and the cathode terminal pin.

15. The integral electrochemical device of claim 14, wherein the anode terminal pin is substantially parallel to the anode, and wherein the cathode terminal pin is substantially parallel to the cathode.

16. The integral electrochemical device of claim 1, wherein the anode terminal pin is electrically connected to the terminal surface to facilitate the terminal surface being a terminal of the integral electrochemical device.

17. The integral electrochemical device of claim 1, further comprising:
a second anode;
an anode disk disposed between an anode terminal portion of the anode and a second anode terminal portion of the second anode;
a second cathode; and
a cathode disk disposed between a cathode terminal portion of the cathode and a second cathode terminal portion of the second cathode.

18. The integral electrochemical device of claim 1, further comprising:
an anode pin isolating feed through disposed between the anode terminal pin and the terminal surface; and
a cathode pin isolating feed through disposed between the cathode terminal pin and the terminal surface.

19. A medical apparatus, comprising:
an electrode stack comprising an anode and a cathode, wherein the electrode stack is configured to power the medical apparatus;
an anode terminal pin electrically coupled with the anode;
a cathode terminal pin electrically coupled with the cathode;
a terminal surface configured to receive the anode terminal pin and the cathode terminal pin; and
a shared surface configured to interface with the terminal surface to house the electrode stack.

20. A method, comprising:
forming an anode hole in an anode and a cathode hole in a cathode;
inserting an anode terminal pin through the anode hole;
inserting a cathode terminal pin through the cathode hole;
securing a terminal surface to the anode terminal pin and the cathode terminal pin; and
securing the terminal surface to a shared surface of an apparatus, wherein the anode and the cathode provide power to the apparatus.

21. The method of claim 20, further comprising cutting an angled slot in the anode and an angled slot in the cathode to facilitate an electrical connection between the anode and the anode terminal pin and between the cathode and the cathode terminal pin.

22. The method of claim 20, further comprising laser welding the anode terminal pin to the anode and the cathode terminal pin to the cathode.

23. The method of claim 20, further comprising stacking the anode and the cathode within a cell pack insulator, wherein the cell pack insulator serves as a stacking aid.

24. An electrochemical device, comprising:
an anode terminal pin electrically coupled with an anode;
a cathode terminal pin electrically coupled with a cathode;
a terminal surface configured to receive the anode terminal pin and the cathode terminal pin; and
a shared surface configured to interface with the terminal surface to produce an electrode housing, wherein the shared surface is configured to be shared between the integral electrochemical device and an apparatus that is configured to receive power from the integral electrochemical device.
